(19) United States
(12) Patent Application Publication
(10) Pub. No.: US 2014/0100981 A1
(43) Pub. Date: Apr. 10, 2014

(54) SYSTEM, DEVICE AND METHOD FOR PROVIDING DISTRIBUTED PRODUCT SHOPPING SERVICES

(71) Applicant: Nextag, Inc., San Mateo, CA (US)

(72) Inventors: Jean-Sebastien Brien, San Francisco, CA (US); David Aki Aoyama, San Francisco, CA (US); David Berger, San Mateo, CA (US)

(73) Assignee: Nextag, Inc., San Mateo, CA (US)

(21) Appl. No.: 14/051,399

(22) Filed: Oct. 10, 2013

Related U.S. Application Data
(60) Provisional application No. 61/712,117, filed on Oct. 10, 2012.

(51) Int. Cl. G06Q 30/06

(52) U.S. Cl. CPC G06Q 30/0601
USPC 705/26.1

(57) ABSTRACT

A distributed shopping services system includes a host server that is utilized to create and operate one or more silhouette websites. These silhouette websites are located on subdomains of the domains of one or more corresponding merchant websites operated by merchant servers. The host server receives data about each of the merchant websites and stores the data in a merchant database such that based on the data, the host server is able to both ensure the silhouette websites look and feel like the corresponding merchant websites and provide e-commerce functionality for the products of the merchant websites.

### RELATED APPLICATION(S)

This Patent Application claims priority under 35 U.S.C. §119(e) of the co-pending, co-owned U.S. Provisional Patent Application No. 61/712,117, filed Oct. 10, 2012, and entitled “SILHOUETTE CONCEPT” which is also hereby incorporated by reference in its entirety.

### FIELD OF THE INVENTION

The present invention relates to the field of distributed e-commerce. More specifically, the present invention relates to the field of distributing e-commerce services across multiple domains.

### BACKGROUND OF THE INVENTION

The Domain Name System (DNS) is a hierarchical distributed naming system for computers, services, or any resource connected to the Internet or a private network. It associates various information with domain names assigned to each of the participating entities. Most prominently, it translates easily memorized domain names to the numerical IP addresses needed for the purpose of locating computer services and devices worldwide. An oft-used analogy to explain the DNS is that it serves as the phone book for the Internet by translating human-friendly computer hostnames into IP addresses. For example, the domain name www.example.com translates to the addresses 192.0.43.10 (IPv4) and 2001:500:88:200::10 (IPv6).

The DNS has a tree structure or hierarchy, with each non-resource record node on the tree being a domain name. A subdomain is a domain that is part of a larger domain; the only domain that is not also a subdomain is the root domain. For example, west.example.com and east.example.com are subdomains of the example.com domain, which in turn is a subdomain of the .com top-level domain (TLD). A “subdomain” expresses relative dependence, not absolute dependence: for example, wikipedia.org comprises a subdomain of the org domain, and en.wikipedia.org comprises a subdomain of the domain wikipedia.org. In theory, this subdivision can go down to 127 levels deep, and each DNS label can contain up to 63 characters, as long as the whole domain name does not exceed a total length of 255 characters. But in practice most domain registries limit at 253 characters.

Generally, merchants that operate an e-commerce website on a domain use subdirectories instead of subdomains to organize the content they wish to make available on the Internet. Further, even when merchants utilize subdomains, they retain control of the operation of the subdomains and operate the webpages on those domains with the same servers that operate the webpages on the principal domain.

### SUMMARY OF THE INVENTION

A distributed shopping services system comprises a host server that is utilized to create and operate one or more silhouette websites. These silhouette websites are located on subdomains of the domains of one or more corresponding merchant websites operated by merchant servers. The host server receives data about each of the merchant websites and stores the data in a merchant database such that based on the data, the host server is able to both ensure the silhouette websites look and feel like the corresponding merchant websites and provide e-commerce functionality for the products of the merchant websites. To a consumer, the silhouette websites appear to simply be a part of the other merchant websites and operate as such. As a result, the merchants that control the merchant websites are able to leverage the e-commerce tools of the host to sell their e-commerce products without needing to understand or access the host and its host server software/hardware. This beneficially simultaneously provides protection for the host and enhanced sales, marketing and other tools to the merchants

In one aspect, a system for providing distributed shopping services comprises one or more merchant servers, wherein each of the merchant servers operate a merchant website on a merchant domain that points to the corresponding merchant server, a merchant database coupled with the merchant servers, wherein the database receives data about each of the merchant websites from the merchant servers and stores the data as separate merchant website entries and a host server coupled with the merchant database and having a service module, wherein for each of the merchant websites the host server operates a silhouette website on a silhouette domain that is a subdomain of the merchant domain of the corresponding merchant website, wherein the service module provides shopping services on each of the silhouette websites based on the merchant website entry that is associated with the merchant website that corresponds to the silhouette website. In some embodiments, the data about each of the merchant websites comprises each of the silhouette domains, and each of the silhouette domains point to the host server such that the silhouette websites are stored on and accessed by consumers at the host server. In some embodiments, the merchants that control the merchant websites and the host that controls the service module are separate entities. In some embodiments, the data about each of the merchant websites comprises a product catalogue of the merchant website including a set of products, product prices and product descriptions. In some embodiments, upon selection of one or more of the set of products and a checkout command by a consumer on one of the silhouette websites, the host server transfers the consumer from the silhouette website to the merchant website associated with the silhouette websites such that the purchase of the one or more of the set of products is performed on the merchant website. In some embodiments, the host server periodically requests each of the merchant servers to submit updated product catalogues to the merchant database such that the merchant database is able to replace the product catalogues within the data with the updated product catalogues. In some embodiments, the shopping services comprise a product search engine that receives queries and produces results lists of products of the set of products based on the received queries. In some embodiments, the data about each of the merchant websites comprises product ranking data that indicates priorities among the set of products, wherein the service module adjusts the manner in which the set of products are ranked within results list produced by queries of the product search engine. In some embodiments, the data about each of the merchant websites comprises data indicating the format and style of webpages of the merchant website. In some embodiments, each of the silhouette websites are configured to have the same format and style as the corresponding merchant website based on the merchant website entry of the corresponding merchant website. In some embodiments, the host server blocks the silhouette websites from being indexed by search engines. In some embodiments, the shopping services comprise a product recommendation feature that suggests products to consumers on the silhouette websites based on information acquired about the consumer on the silhouette websites and on the corresponding merchant websites.

In another aspect, a method of providing distributed shopping services comprise operating a merchant website on a merchant domain with one or more merchant servers, wherein the merchant domain points to the merchant servers, transmitting data about the merchant website from the merchant servers to a merchant database and storing the data as a separate merchant website entry on the merchant database, operating a silhouette website on a silhouette domain with a host server having a service module, wherein the silhouette domain is a subdomain of the merchant domain and providing shopping services on the silhouette website with the service module based on the merchant website entry. In some embodiments, the data about the merchant website comprises the silhouette domain, and the silhouette domain points to the host server such that the silhouette website is stored on and accessed by consumers at the host server. In some embodiments, the merchant that controls the merchant website and the host that controls the service module are separate entities. In some embodiments, the data about the merchant website comprises a product catalogue of the merchant website including a set of products, product prices and product descriptions. In some embodiments, the method further comprises upon selection of one or more of the set of products and a checkout command by a consumer on the silhouette website, transferring the consumer from the silhouette website to the merchant website such that the purchase of the one or more of the set of products is performed on the merchant website. In some embodiments, the method further comprises periodically sending requests from the host server to the merchant server to submit an updated product catalogue to the merchant database such that the merchant database is able to replace the product catalogue within the data with the updated product catalogue. In some embodiments, the shopping services comprise a product search engine that receives queries and produces results lists of products of the set of products based on the received queries. In some embodiments, the data about of the merchant website comprises product ranking data that indicates priorities among the set of products, wherein the service module adjusts the manner in which the set of products are ranked within results list produced by queries of the product search engine. In some embodiments, the data about the merchant website comprises data indicating the format and style of webpages of the merchant website. In some embodiments, the method further comprises configuring the silhouette website to have the same format and style as the corresponding merchant website based on the merchant website entry. In some embodiments, the method further comprises blocking the silhouette website from being indexed by search engines with the host server. In some embodiments, the shopping services comprise a product recommendation feature that suggests products to consumers on the silhouette website based on information acquired about the consumer on the silhouette website and on the merchant website.

In yet another aspect, a system for providing distributed shopping services comprises a merchant database coupled with one or more merchant servers, wherein each of the merchant servers operate a merchant website on a merchant domain that points to the corresponding merchant server and further wherein the database receives data about each of the merchant websites from the merchant servers and stores the data as separate merchant website entries and a host server coupled with the merchant database and having a service module, wherein for each of the merchant websites the host server operates a silhouette website on a silhouette domain that is a subdomain of the merchant domain of the corresponding merchant website, wherein the service module provides shopping services on each of the silhouette websites based on the merchant website entry that is associated with the merchant website that corresponds to the silhouette website. In some embodiments, the data about each of the merchant websites comprises each of the silhouette domains, and each of the silhouette domains point to the host server such that the silhouette websites are stored on and accessed by consumers at the host server. In some embodiments, the merchants that control the merchant websites and the host that controls the service module are separate entities. In some embodiments, the data about each of the merchant websites comprises a product catalogue of the merchant website including a set of products, product prices and product descriptions. In some embodiments, upon selection of one or more of the set of products and a checkout command by a consumer on one of the silhouette websites, the host server transfers the consumer from the silhouette website to the merchant website associated with the silhouette websites such that the purchase of the one or more of the set of products is performed on the merchant website. In some embodiments, the host server periodically requests each of the merchant servers to submit updated product catalogues to the merchant database such that the merchant database is able to replace the product catalogues within the data with the updated product catalogues. In some embodiments, the shopping services comprise a product search engine that receives queries and produces results lists of products of the set of products based on the received queries. In some embodiments, the data about each of the merchant websites comprises product ranking data that indicates priorities among the set of products, wherein the service module adjusts the manner in which the set of products are ranked within results list produced by queries of the product search engine. In some embodiments, the data about each of the merchant websites comprises data indicating the format and style of webpages of the merchant website. In some embodiments, each of the silhouette websites are configured to have the same format and style as the corresponding merchant website based on the merchant website entry of the corresponding merchant website. In some embodiments, the host server blocks the silhouette websites from being indexed by search engines. In some embodiments, the shopping services comprise a product recommendation feature that suggests products to consumers on the silhouette websites based on information acquired about the consumer on the silhouette websites and on the corresponding merchant websites.

### BRIEF DESCRIPTION OF THE DRAWINGS

FIG. 1 illustrates a distributed shopping service system according to some embodiments.

FIG. 2 illustrates a flow chart of a method of providing distributed shopping services according to some embodiments.

FIG. 3 illustrates a block diagram of an exemplary host server according to some embodiments.

### DETAILED DESCRIPTION OF THE PREFERRED EMBODIMENT

Embodiments of the present application are directed to systems, methods and devices for providing distributed shopping services. The systems, method and devices are able to comprise one or more merchant servers, wherein each of the merchant servers operate a merchant website on a merchant domain that points to the corresponding merchant server. A merchant database coupled with the merchant servers, wherein the database receives data about each of the merchant websites from the merchant servers and stores the data as separate merchant website entries. A host server coupled with the merchant database and having a service module, wherein for each of the merchant websites the host server operates a silhouette website on a silhouette domain that is a subdomain of the merchant domain of the corresponding merchant website, wherein the service module provides shopping services on each of the silhouette websites based on the merchant website entry that is associated with the merchant website that corresponds to the silhouette website.

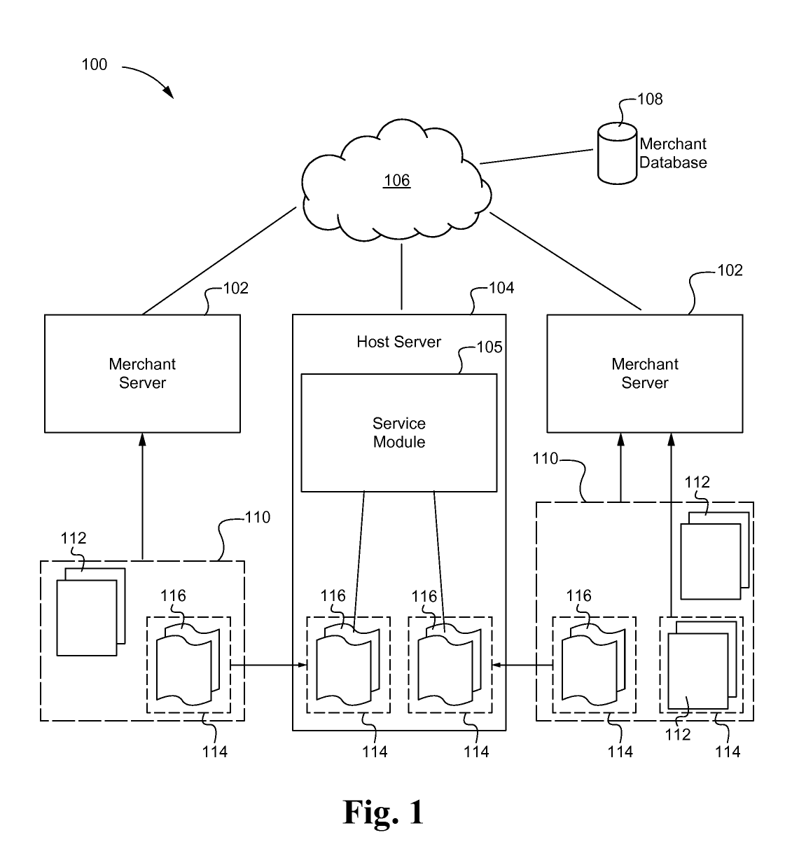

FIG. 1 illustrates a distributed shopping service system 100 according to some embodiments. As shown in FIG. 1, the distributed shopping server system 100 comprises one or more merchant servers 102, one or more host servers 104 and a merchant database 108, all coupled together via one or more networks 106. The merchant servers 102 and/or host servers 104 are each able to comprise non-transitory computer-readable memory and one or more processors for executing data input from the network 106 and/or stored on the memory (not shown). In addition, the host servers 104 are able to comprise a service module 105 (stored on the memory) that when executed provides one or more e-commerce shopping services (as described in detail below). The merchant database 108 is stored on non-transitory computer-readable memory and is able to be located on the host servers 104, the merchant servers 102, or a combination thereof. Alternatively, the merchant database 108 is able to be separate from the host servers 104 and/or merchant servers 102, but accessible by the host and merchant servers 102, 104. In some embodiments, the merchant database 108 is mirrored and/or synchronized in multiple locations (e.g. servers). Alternatively, the merchant database 108 is able to be a single global database that is located on a single device or distributed across a plurality of devices. The networks 106 are able to be one or a combination of wired or wireless networks as are well known in the art. Although as shown in FIG. 1 two merchant servers 102 are coupled with one host server 104 and one merchant database 108 via one network 106, it is understood that any number of networks 106, merchant servers 102, host servers 104 and/or merchant databases 108 are able to used in the system 100.

As shown in FIG. 1, the merchant servers 102 are able to store and operate one or more merchant websites 112 on a merchant website domain 110 that points to the merchant servers 102 as the host of the websites 110. For example, the merchant servers 102 are each able to store and operate an e-commerce website on a DNS domain such as merchantwebsite.com. This merchantwebsite.com domain is associated with a unique IP address such that users that wish to access the merchant website 112 type in the website domain 110 and are directed to the website on the merchant servers 102 at the unique IP address. Typically, the website domain 110 itself is also associated with the merchant that controls the merchant servers 102. For example, merchant servers 102 controlled by a company or entity such as Pepsi co. will often operate e-commerce websites 112 at website domains 110 like “pepsi.com” or “pepsico.com” such that a user will more easily find and remember the website domain 110 by remembering the merchant name.

As also shown in FIG. 1, each of the merchant domains 110 are able to have one or more subdomains 114. Like the domains 110, these subdomains 114 are able to have IP addresses that point at the same or different servers as the merchant domains 110. For example, the merchant domain 110 of merchantwebsite.com is able to have a subdomain 114 of search.merchantwebsite.com where another website or webpage is located. In particular, as shown in FIG. 1, a first merchant domain 110 has a single subdomain 114 that points to the host server 104 instead of the merchant server 102 (that the merchant domain 110 points to), and a second merchant domain 110 has a plurality of subdomains 114 wherein one points to the merchant server 102 and the other to the host server 104. Alternatively, it is contemplated that each merchant domain 110 is able to have any number of subdomains 114 (or subdomains of subdomains) that point to the same or different servers as their “parent” domains and the other subdomains 114. As a result, a single “main” domain of a merchant is able to be used to create one or more subdomains that share the main domain name (and the top level domain), but are able to point to different IP addresses and/or servers. This provides the advantage of creating websites at multiple locations that are separately discoverable by web search engines (e.g.

Google) and/or webcrawlers and are able to have customizable different content while still being readily associated together by the main domain name.

As shown in FIG. 1, two of the subdomains 114 of the merchant domains 110 point to and/or are hosted by the host server 104 instead of the merchant servers 102 that host the “parent” merchant domains 110. In particular, the host server 104 is able to create, store and/or operate one or more silhouette websites 116 on each of the subdomains 114 such that when a user attempts to access the subdomains 114 they are directed to the silhouette websites 116 as they operate on the host server 104. In this way, the host server 104 is able to implement the service module 105 on each of the silhouette websites 116 thereby providing the shopping services of the service module 105 on each of the websites 116. Thus, the system 100 is able to provide the advantage of distributing the shopping services of the service module 105 on multiple different websites 116 on subdomains 114 of different merchants without ceding control of the service module 105 to each of the merchants For example, a merchant with an e-commerce website with limited analytic and shopping services is able to gain access to the services of the service module 105 by simply creating a subdomain of the e-commerce website domain and assigning the domain to the host server 104 instead of the merchant server 102 that the e-commerce website is run on.

To a consumer, the silhouette website 116 on the subdomain 114 appears to simply be a part of the merchant website 112. In particular, the silhouette websites 116 (and their user interface) are able to have the same format, look and feel as the merchant websites 112 (and their user interface) of which they are on a subdomain 114 of. For example, the silhouette websites 116 are able to have the same header, masthead, footer, font, style, window configuration, code language, metadata, tags, and/or other types of format as the merchant websites 112 to which they correspond. As a result, when combined with the subdomain/domain relationship between the silhouette websites 116 and the merchant websites 112, the similarity in appearance of the websites 112, 116 provides the advantage of creating a seamless transition for users from a merchant website 112 to a silhouette website 116 or vice versa.

The merchant database 108 is able to store merchant data about each of the merchant websites 112 necessary to implement corresponding silhouette websites 116. The merchant data is organized by merchant website 112 such that each merchant website 112 has a separate entry within the database where data related to the merchant website 112 is stored. Alternatively, the merchant data is able to be organized by merchant such that, if a merchant has a plurality of websites 112 that have corresponding silhouette websites 116, the likely overlapping data about the websites 112 is not repeated in separate entries. In some embodiments, the merchant data for each merchant entry comprises one or more of the merchant domain 110, the IP address and/or server associated with the merchant domain 110, the subdomain 114, the IP address and/or server associated with the subdomain 114, format data of the merchant website 112, a product catalogue for the website 112, product search optimization data, social channel data and/or tracking data for the website 112.

In some embodiments, the format data comprises one or more of a header, masthead, footer, font, style, window configuration, code language, metadata, tags, and/or other types of format data of the merchant website 112. In some embodiments, the host server 104 is able to access or crawl the merchant website 112 on the merchant server 102 in order to automatically obtain or parse the format data from the merchant website 112. Alternatively, the merchant operating the merchant website 112 and/or the merchant server 112 is able to transmit or select the format data for submission to the merchant database 108. In some embodiments, the product catalogue comprises a list of one or more products for sale on the merchant website 112, and for each product one or more of a current product availability/inventory, a product description, a product price and/or current discounts/sales that apply to the product. In some embodiments, the product search optimization data comprises keyword ranking/weighting preferences and/or other types of query or product ranking adjustment preferences. In some embodiments, the social channel data comprises one or more websites (e.g. Facebook, Google) or other media channels where links to the silhouette website 116 are to be provided or not provided as specified in the data. In some embodiments, the tracking data comprises one or more of user/purchaser profile data (e.g. user identification data, user purchase history, user demographics, user preferences), purchase conversion data and/or sales data (e.g. product, price, average order volume). All of this merchant data is accessible by the host server 104 such that the host server 104 and the service module 105 are able to implement the silhouette websites 116 based on the merchant data.

In some embodiments, the merchant database 108 receives the merchant data and stores the data in the associated merchant entry by actively downloading the data from the merchant servers 102. In some embodiments, the host server 104 transmits one or more update request messages to the database 108 and/or merchant servers 102 that request the merchant entries be updated. Alternatively or in addition, the merchant data is able to be uploaded or “pushed” onto the merchant database 108 from the merchant servers 102 for storage in the appropriate merchant entry. In some embodiments, the transfer of merchant data to the database 108 is performed periodically by the merchant servers 102 and/or host server 104. Alternatively, the transfer of merchant data is able to be performed one or more of periodically, on demand or dynamically as a user accesses the associated silhouette website 116. As a result, the merchant database 108 is able to provide all the data required in order for the host server 104 (with the service module 105) to create and operate silhouette websites 116 that have the same format as the corresponding merchant websites 112, but that also provide the service module 105 shopping services to the merchant website 112 product catalogue.

The service module 105 is able to comprise one or more of a product search feature, product recommendation feature, a data aggregation feature, search engine marketing feature, a search engine optimization feature, a banner re-targeting feature, a social advertising feature, a multi-channel optimization feature and/or a check-out feature. The product search feature enables a user to input a search query into a search engine on the silhouette websites 116 and applies a search algorithm to the product catalogue data of the merchant entry of the associated merchant website 112. Specifically, the search algorithm is used to rank and display one or more of the products in the product catalogue of the merchant website 112 based on the query terms. The product search feature is able to incorporate one or more of keyword searches, categorical searches, parametric searches and/or dichotomous key searches.

Upon selection of one or more of the products displayed by the search feature, the search feature is able to automatically transfer the user web browser (and thus the user) to a page on the merchant website 112 associated with the selected products. As a result, the search feature provides the benefit of enabling users to seamlessly gain further information about the product directly from the merchant website 112 after finding the product using the search feature. In some embodiments, this correlation between one or more products and one or more pages on the merchant website 112 is able to be a part of the merchant data stored and updated in the merchant database 108. In such embodiments, the search feature is able to compare the selected products to the merchant data within the merchant database 108 in order to determine the webpage of the merchant website 112 where the user is to be transferred upon selection of the products. Alternatively, the search feature is able to transfer the user a webpage of the silhouette website 116 that includes the further information about the product instead of transferring the user to the merchant website 112. In such embodiments, the merchant data is able to comprise further information about each product such that the service module 105 is able to display the further information on the silhouette website 116 upon selection of each product.

The product recommendation feature causes host server 104 (and thus the silhouette website 116) to display one or more recommended products that may be of interest to a user based on the current interactions of the user on the silhouette website 116 and/or on the user profile data stored in the merchant entry for the user. For example, user interactions such as the selecting or “liking” of one or more first products are able to be used to provide recommendations of other products from the product catalogue. Alternatively or in addition, recommendations are able to be made based on prior interactions (e.g. purchased items, saved items, viewed items, user demographic data or other user profile data) and the product catalogue. The data aggregation feature causes the host server 104 to collect, organize and transmit data about the users and/or products based on interactions of the users and the silhouette websites 116. For example, the server 104 is able to collect any data about the user or product that is described in relation to the merchant entries and transmit the data to the merchant database 108 and/or merchant servers 102 to update the merchant database 108 and/or as a report for use by the merchant servers 102 in operating the merchant websites 112.

The search engine marketing feature enables the host server 102 and/or service module 105 to initiate keyword bidding and placement of product advertisement on search engines or other locations based on the social channel data or other preference data indicated by the merchant within the merchant entry. The search engine optimization feature enables the search engine algorithm to be optimized based on the product search optimization data. For example, the weighting of one or more search terms, one or more products, or other factors within the search algorithm are able to be adjusted based on the product search optimization data such that the ranking of the products is prioritized. The banner re-targeting and social advertising features enable the host server 102 and/or service module 105 to initiate the placement of product banner ads or other types of advertisements on one or more specified websites or other locations based on the social channel data or other preference data indicated by the merchant within the merchant entry.

The check-out feature is able to receive user input on the silhouette websites 116 that one or more products from the product catalogue have been selected for purchase. Upon receiving the selection, the check-out feature is able to automatically transfer the user web browser (and thus the user) to the merchant website 112 (located on the “parent” domain 110 of the silhouette website 116 on which the purchase selection was made). As a result, the host server 104 is not required to accept or transfer money to the merchant servers 102 as the money is collected directly by the merchants via the merchant websites 112. Alternatively, the user browser is able to be transferred by the check-out feature to another website (e.g. on another domain or subdomain) that either points to the merchant server 102 or a third party server where the purchase is able to be executed. Alternatively, the silhouette website 116 is able to comprise a local checkout feature such that purchases are able to take place on the silhouette website 116 without transfer of the user to the merchant website 112. In such embodiments, the host server 104 and the service module 105 are able to be configured to transfer some or all of the received funds as well as the transaction data to the merchant database 108 and/or the merchant via the merchant servers 102. As a result, the service module 105 is able to optimize the revenue of the merchant using site monetization and traffic acquisition services. Further, the module 105 is able to identify traffic sources that are monetizing well for the products of the merchant and optimize the silhouette websites 116 to achieve a desired cost of sale for the merchant.

In operation, the merchant servers 102 create one or more subdomains 114 for the merchant domains 110 of the merchant websites 112 that operate on the merchant servers 102. The subdomains 114 have IP addresses that point to the host server 104. As a result, the host server 104 is able to create and run a silhouette website 116 for each of the merchant websites 112 on the subdomain 114 of the merchant websites 112. Merchant data about each of the merchant websites 112 is transferred to the merchant database 108 where it is stored and updated as separate merchant entries. Based on this merchant data, the host server 104 is able to utilize the service module 105 to implement one or more shopping services on the silhouette websites 116, wherein the services correspond to the data within the merchant entry associated with the corresponding merchant websites 112. Further, based on the merchant data, the silhouette websites 116 are able to be configured to have the same format as the corresponding merchant website 112 such that they have the same look and feel to a user visiting the websites. Subsequently, upon selecting one or more products for purchase on the silhouette websites 116, the host server 104 is configured to transfer the user to the check-out page of the corresponding merchant website 112 for processing the purchase. Additionally, based on some or all of the user interactions with the silhouette websites 116, the host server 104 is able to report and analyze analytic data/feedback to the merchants that control the merchant websites 112. Thus, the system 100 provides the advantage of enabling multiple third party merchants to leverage the shopping services of the service module 105 of the host server 104 without having to maintain the host server 104 themselves or the host having to relinquish control of the host server 104 to the service module 105 to the merchants.

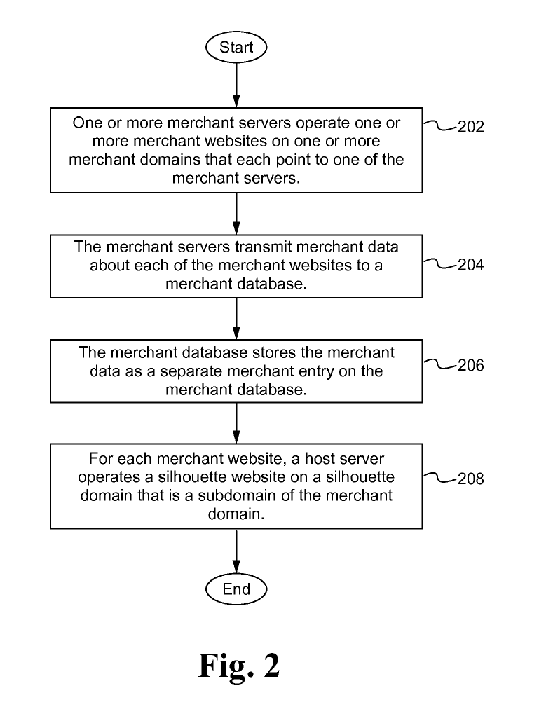

FIG. 2 illustrates a flow chart of a method of providing distributed shopping services according to some embodiments. It is understood that one or more of the below method steps are able to be omitted and/or additional method steps are able to be added. As shown in FIG. 2, one or more merchant servers 102 operate one or more merchant websites 112 on one or more merchant domains 110 that each point to one of the merchant servers 102 at the step 202. In some embodiments, one or more of the merchant servers 102 operate a plurality of merchant websites 112 on a merchant domain 110 that points to the merchant server 102. The merchant servers 102 transmit merchant data about each of the merchant websites 112 to a merchant database 108 at the step 204. In some embodiments, the merchant database 108 actively downloads the merchant data. Alternatively, the merchant data is pushed to the merchant database 108 by the merchant servers 102. The merchant database 108 stores the merchant data as a separate merchant entries on the merchant database at the step 206. For each merchant website 112, a host server 104 operates a silhouette website 116 on a silhouette domain 114 that is a subdomain of the merchant domain 110 at the step 208. Thus, using a service module 105 on the host server 104, the host server 104 is able to provide shopping services on each of the silhouette websites 116 based on a merchant website entry in the merchant database 108 that corresponds to the parent domain of subdomain 114 of each of the silhouette websites 116.

In some embodiments, the merchant data comprises the silhouette domain 114, and the silhouette domain 114 points to the host server 104 such that the silhouette website 116 is stored on and accessed by consumers at the host server 104. In some embodiments, the merchants that control the merchant websites 112 and the host that controls the service module 105 on the host server 104 are separate entities. In some embodiments, each of the merchant entries in the merchant database 108 comprises a product catalogue of the corresponding merchant website 112 including a set of products, product prices and product descriptions from the merchant website 112. In some embodiments, the method further comprises upon selection of one or more of the set of products and a checkout command by a consumer on a silhouette website 116, automatically transferring the consumer from the silhouette website 116 to the corresponding merchant website 112 with the host server 104 such that the purchase of the one or more of the set of products is performed on the merchant website 112. In some embodiments, the method further comprises the host server 104 and/or merchant database 108 periodically sending requests to the merchant servers 102 to submit an updated product catalogues to the merchant database 108 such that the merchant database 108 is able to replace the product catalogue within the merchant data with the updated product catalogue. In some embodiments, the shopping services comprise a product search engine that receives queries and produces results lists of products of the set of products based on the received queries.

In some embodiments, the merchant data comprises product ranking data that indicates priorities among the set of products, wherein the service module adjusts the manner in which the set of products are ranked within results list produced by queries of the product search engine. In some embodiments, the merchant data comprises data indicating the format and style of webpages of the merchant website 112. In some embodiments, the method further comprises the host server 104 configuring the silhouette websites 116 to have the same format and style as the corresponding merchant websites 112 based on the merchant website entry within the merchant database 108 associated with the corresponding merchant website 112. In some embodiments, the method further comprises the host server 104 blocking the silhouette websites 116 from being indexed by search engines. In some embodiments, the shopping services comprise a product recommendation feature that suggests products to consumers on the silhouette website 116 based on information acquired about the consumer on the silhouette website 116 and on the merchant website 112. As a result, the method provides the advantage of enabling multiple third party merchants to leverage the shopping services of the service module 105 of the host server 104 without having to maintain the host server 104 themselves or the host having to relinquish control of the host server 104 to the service module 105 to the merchants

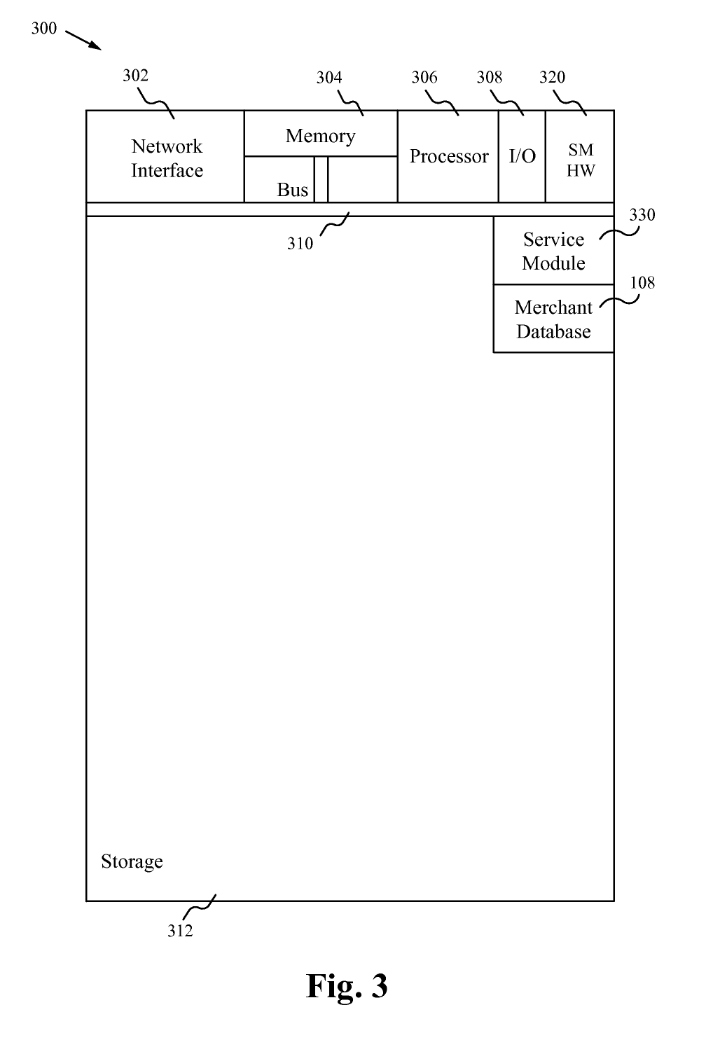

FIG. 3 illustrates a block diagram of an exemplary host server 300 according to some embodiments. In some embodiments, the merchant servers 102 are able to be substantially similar to the host server 300 as described below except without the service module 420/430. The host server 300 is able to be any computing device or combination of devices that are able to acquire, store, compute, communicate and/or display information such as images and videos. In general, a hardware structure suitable for implementing the host server 300 comprises a network interface 302, a memory 304, a processor 306, I/O device(s) 308, a bus 310 and a storage device 312. Alternatively, one or more of the illustrated components are able to be removed or substituted for other components well known in the art. In some embodiments, the host server 300 is able to store all or part of the merchant database 108. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, flash memory card or any other storage device. The host server 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. The host server 300 is able to store the service module software 330 in the storage device 312 and memory 304 and processed the module with the processor 306. In some embodiments, service module hardware 320 is included. In particular, although the computing device 300 in FIG. 3 includes service module software 330 and service module hardware 320 for implementing the service module 105, it is understood that the service module 105 is able to be implemented in solely in hardware, firmware or software, or in a combination thereof. In some embodiments, the service module 320/330 is able to include several applications and/or modules. In some embodiments, the service module 320/330 includes a separate module for each of the features described above.

Although it is understood that the highest level domains are top level domains (e.g. .com, .org, .gov), as used herein, “domain” is referring to subdomains of the top level domains (e.g. example.com, help.org, place.gov). Accordingly, as used herein, “subdomain” is referring to a subdomain of the described “domains” (e.g. uk.example.com, faq.help.org, search.place.gov) or further subdomains thereof (e.g. color.productsearch.uk.example.com). Additionally, the distinction between a subdomain and a subdirectory should be noted. In particular, subdirectories are folders or subfolders of data of a website that are all located on a single address associated with the domain or subdomain and that form the organization of the website on that domain or subdomain. In contrast, subdomains are separate websites from the parent domain that they are “sub” to, and thus are able to located at different addresses than their parent domain(s).

The distributed shopping services system provides numerous advantages. In particular, to a consumer, the silhouette websites appear to simply be a part of the other merchant websites and operate as such. As a result, the merchants that control the merchant websites are able to leverage the e-commerce tools of the host to sell their e-commerce products without needing to understand or access the host and its host server software/hardware. This beneficially simultaneously provides protection for the host and enhanced sales, marketing and other tools to the merchants.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. For example, instead of the entire subdomain 114 pointing to the host server 104, a search engine or other searching features (such as those provided by the service module 105) are able to be utilized on the merchant websites 112 that point to the host server 104. As a result, the host server 104 is able to “power” the search engine and/or other features on the merchant websites 112.

What is claimed is:

1. A system for providing distributed shopping services, the system comprising:
a. one or more merchant servers, wherein each of the merchant servers operate a merchant website on a merchant domain that points to the corresponding merchant server;
b. a merchant database coupled with the merchant servers, wherein the database receives data about each of the merchant websites from the merchant servers and stores the data as separate merchant website entries; and
c. a host server coupled with the merchant database and having a service module, wherein for each of the merchant websites the host server operates a silhouette website on a silhouette domain that is a subdomain of the merchant domain of the corresponding merchant website;
wherein the service module provides shopping services on each of the silhouette websites based on the merchant website entry that is associated with the merchant website that corresponds to the silhouette website.

2. The system of claim 1 wherein the data about each of the merchant websites comprises each of the silhouette domains, and each of the silhouette domains point to the host server such that the silhouette websites are stored on and accessed by consumers at the host server.

3. The system of claim 1 wherein the merchants that control the merchant websites and the host that controls the service module are separate entities.

4. The system of claim 1 wherein the data about each of the merchant websites comprises a product catalogue of the merchant website including a set of products, product prices and product descriptions.

5. The system of claim 4 wherein upon selection of one or more of the set of products and a checkout command by a consumer on one of the silhouette websites, the host server transfers the consumer from the silhouette website to the merchant website associated with the silhouette websites such that the purchase of the one or more of the set of products is performed on the merchant website.

6. The system of claim 4 wherein the host server periodically requests each of the merchant servers to submit updated product catalogues to the merchant database such that the merchant database is able to replace the product catalogues within the data with the updated product catalogues.

7. The system of claim 4 wherein the shopping services comprise a product search engine that receives queries and produces results lists of products of the set of products based on the received queries.

8. The system of claim 7 wherein the data about each of the merchant websites comprises product ranking data that indicates priorities among the set of products, wherein the service module adjusts the manner in which the set of products are ranked within results list produced by queries of the product search engine.

9. The system of claim 1 wherein the data about each of the merchant websites comprises data indicating the format and style of webpages of the merchant website.

10. The system of claim 9 wherein each of the silhouette websites are configured to have the same format and style as the corresponding merchant website based on the merchant website entry of the corresponding merchant website.

11. The system of claim 1 wherein the host server blocks the silhouette websites from being indexed by search engines.

12. The system of claim 1 wherein the shopping services comprise a product recommendation feature that suggests products to consumers on the silhouette websites based on information acquired about the consumer on the silhouette websites and on the corresponding merchant websites.

13. A method of providing distributed shopping services, the method comprising:
a. operating a merchant website on a merchant domain with one or more merchant servers, wherein the merchant domain points to the merchant servers;
b. transmitting data about the merchant website from the merchant servers to a merchant database and storing the data as a separate merchant website entry on the merchant database;
c. operating a silhouette website on a silhouette domain with a host server having a service module, wherein the silhouette domain is a subdomain of the merchant domain; and
d. providing shopping services on the silhouette website with the service module based on the merchant website entry.

14. The method of claim 13 wherein the data about the merchant website comprises the silhouette domain, and the silhouette domain points to the host server such that the silhouette website is stored on and accessed by consumers at the host server.

15. The method of claim 13 wherein the merchant that controls the merchant website and the host that controls the service module are separate entities.

16. The method of claim 13 wherein the data about the merchant website comprises a product catalogue of the merchant website including a set of products, product prices and product descriptions.

17. The method of claim 16 further comprising upon selection of one or more of the set of products and a checkout command by a consumer on the silhouette website, transferring the consumer from the silhouette website to the merchant website such that the purchase of the one or more of the set of products is performed on the merchant website.

18. The method of claim 16 further comprising periodically sending requests from the host server to the merchant server to submit an updated product catalogue to the merchant database such that the merchant database is able to replace the product catalogue within the data with the updated product catalogue.

19. The method of claim 16 wherein the shopping services comprise a product search engine that receives queries and produces results lists of products of the set of products based on the received queries.

20. The method of claim 19 wherein the data about of the merchant website comprises product ranking data that indicates priorities among the set of products, wherein the service module adjusts the manner in which the set of products are ranked within results list produced by queries of the product search engine.

21. The method of claim 13 wherein the data about the merchant website comprises data indicating the format and style of webpages of the merchant website.

22. The method of claim 21 further comprising configuring the silhouette website to have the same format and style as the corresponding merchant website based on the merchant website entry.

23. The method of claim 13 further comprising blocking the silhouette website from being indexed by search engines with the host server.

24. The method of claim 13 wherein the shopping services comprise a product recommendation feature that suggests products to consumers on the silhouette website based on information acquired about the consumer on the silhouette website and on the merchant website.

25. A system for providing distributed shopping services, the system comprising:
a. a merchant database coupled with one or more merchant servers, wherein each of the merchant servers operate a merchant website on a merchant domain that points to the corresponding merchant server and further wherein the database receives data about each of the merchant websites from the merchant servers and stores the data as separate merchant website entries; and
b. a host server coupled with the merchant database and having a service module, wherein for each of the merchant websites the host server operates a silhouette website on a silhouette domain that is a subdomain of the merchant domain of the corresponding merchant website;
wherein the service module provides shopping services on each of the silhouette websites based on the merchant website entry that is associated with the merchant website that corresponds to the silhouette website.

26. The system of claim 25 wherein the data about each of the merchant websites comprises each of the silhouette domains, and each of the silhouette domains point to the host server such that the silhouette websites are stored on and accessed by consumers at the host server.

27. The system of claim 25 wherein the merchants that control the merchant websites and the host that controls the service module are separate entities.

28. The system of claim 25 wherein the data about each of the merchant websites comprises a product catalogue of the merchant website including a set of products, product prices and product descriptions.

29. The system of claim 28 wherein upon selection of one or more of the set of products and a checkout command by a consumer on one of the silhouette websites, the host server transfers the consumer from the silhouette website to the merchant website associated with the silhouette websites such that the purchase of the one or more of the set of products is performed on the merchant website.

30. The system of claim 28 wherein the host server periodically requests each of the merchant servers to submit updated product catalogues to the merchant database such that the merchant database is able to replace the product catalogues within the data with the updated product catalogues.

31. The system of claim 28 wherein the shopping services comprise a product search engine that receives queries and produces results lists of products of the set of products based on the received queries.

32. The system of claim 31 wherein the data about each of the merchant websites comprises product ranking data that indicates priorities among the set of products, wherein the service module adjusts the manner in which the set of products are ranked within results list produced by queries of the product search engine.

33. The system of claim 25 wherein the data about each of the merchant websites comprises data indicating the format and style of webpages of the merchant website.

34. The system of claim 33 wherein each of the silhouette websites are configured to have the same format and style as the corresponding merchant website based on the merchant website entry of the corresponding merchant website.

35. The system of claim 25 wherein the host server blocks the silhouette websites from being indexed by search engines.

36. The system of claim 25 wherein the shopping services comprise a product recommendation feature that suggests products to consumers on the silhouette websites based on information acquired about the consumer on the silhouette websites and on the corresponding merchant websites.
